(19) United States
(12) Patent Application Publication
(10) Pub. No.: US 2004/0008416 A1
(43) Pub. Date: Jan. 15, 2004

(54) Polarization separation element and optical apparatus using the same

(75) Inventor: Takeharu Okuno, Tochigi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/603,892

(22) Filed: Jun. 26, 2003

(30) Foreign Application Priority Data
Jul. 11, 2002 (JP) 2002-202048

(51) Int. Cl. G02B 5/18; G02B 27/44

(52) U.S. Cl. 359/566

(57) ABSTRACT

An optical element includes a substrate; a first diffraction grating disposed on the substrate and having a period that is shorter than a light wavelength used; and a second diffraction grating disposed on the first diffraction grating and having a period that is shorter than the light wavelength used. In the optical element, the melting point of a material of the first diffraction grating is higher than the melting point of a material of the second diffraction grating.

### BACKGROUND OF THE INVENTION

1. Field of the Invention

The present invention relates to a polarization separation element and an optical apparatus using the same. More particularly, the present invention relates to a polarization separation element having a fine structure with a period that is less than a wavelength used.

2. Description of the Related Art

Hitherto, a thin-film polarization separation element making use of Brewster's reflection has been widely used as an element for separating light beams having different polarizations.

However, although such a polarization separation element making use of Brewster's reflection has very good polarization separation capability with respect to light beams having a design incidence angle, its polarization separation capability is rapidly reduced with increasing deviation of the angles of incidence of the light beams from the design incidence angle. FIGS. 22 and 23 illustrate. incidence angle characteristics in terms of polarization separation capability with respect to light having wavelengths of from 400 to 700 nm when the design incidence angle is 45 degrees in a thin-film polarization separation element which transmits p-polarized light and reflects s-polarized light and which makes use of Brewster's reflection. FIGS. 22 and 23 are plots of transmittances and reflectances for the wavelengths of the p-polarized light and the s-polarized light, respectively, when unpolarized light including both a p-polarized component and an s-polarized component is incident upon the polarization separation element. FIG. 22 illustrates transmittance curves Tp and reflectance curves Rp for the p-polarized light. FIG. 23 illustrates transmittance curves Ts and reflectance curves Rs for the s-polarized light. The horizontal axis indicates the angle of incidence and the vertical axis indicates the transmittance for the transmittance curves and the reflectance for the reflectance curves. FIGS. 22 and 23 show that the polarization separation element has very good polarization separation capability at the design incidence angle of 45 degrees, whereas its polarization separation capability is considerably reduced with increasing deviation of the angle of incidence from the design incidence angle. This means that, when such a polarization separation element is used in, for example, a projection optical system of, for example, a liquid crystal projector, contrast is reduced, thereby making it difficult to realize a projection optical system having both high contrast and high luminance.

It has been known for a long time that, when the period of a metallic diffraction grating (wire grid) is made less than the wavelength of light (electromagnetic waves), light beams having different polarizations are separated. A general description and experimental examples thereof are given in, for example, J. P. Auton, “Infrared Transmission Polarizer by Photolithography”, Applied Optics, Vol. 6.1023 (1967). A polarization separation element based on this principle is known to have excellent incidence angle characteristics.

Polarization separation elements based on this principle for visible light or infrared light are disclosed in, for example, Japanese Patent Laid-Open No. 9-288211, and U.S. Pat. Nos. 6,122,103, 6,208,463, and 6,243,199.

Although a polarization separation element using a metal diffraction grating having a period that is shorter than the light wavelength used has excellent incidence angle characteristics, the metallic grating absorbs some of the energy of incident light and converts it into Joule heat.

Although it is desirable that the grating material for providing high polarization separation capability in the visible range be aluminum (Al) when a complex refractive index value is considered, aluminum has a low melting point of approximately 660° C. and has a high diffusion coefficient with respect to a quartz substrate.

Therefore, although the related polarization separation element does not give rise to problems when it is used in, for example, an optical system using a light source having low luminance, it gives rise to heat resistance problems when it is used in, for example, an optical system of a liquid crystal projector having high luminance.

### SUMMARY OF THE INVENTION

Accordingly, it is an object of the present invention to provide a structure having increased durability at high temperatures by disposing between an aluminum diffraction grating and a substrate a metal or a metallic compound having a melting point that is higher than that of aluminum or a small diffusion coefficient with respect to the substrate.

An optical element comprises a substrate; a first diffraction grating disposed on the substrate and having a period that is shorter than a light wavelength used; and a second diffraction grating disposed on the first diffraction grating and having a period that is shorter than the light wavelength used. In the optical element, the melting point of a material of the first diffraction grating is higher than the melting point of a material of the second diffraction grating.

Further objects, features and advantages of the present invention will become apparent from the following description of the preferred embodiments with reference to the attached drawings.

### BRIEF DESCRIPTION OF THE DRAWINGS

FIG. 1 is a front view of the main portion of a polarization separation element of a first embodiment of the present invention.

FIG. 2 is a sectional view of the main portion of the polarization separation element of the first embodiment of the present invention.

FIG. 3 is a enlarged partial sectional view of the main portion of the polarization separation element of the first embodiment of the present invention.

FIG. 4 illustrates incidence angle characteristics in terms of transmittances and reflectances for p-polarized light in the first embodiment of the present invention.

FIG. 5 illustrates incidence angle characteristics in terms of transmittances and reflectances for s-polarized light in the first embodiment of the present invention.

FIG. 6 illustrates incidence angle characteristics in terms of transmittances and reflectances for p-polarized light in a second embodiment of the present invention.

FIG. 7 illustrates incidence angle characteristics in terms of transmittances and reflectances for s-polarized light in the second embodiment of the present invention.

FIG. 8 illustrates incidence angle characteristics in terms of transmittances and reflectances for p-polarized light in a third embodiment of the present invention.

FIG. 9 illustrates incidence angle characteristics in terms of transmittances and reflectances for s-polarized light in the third embodiment of the present invention.

FIG. 10 illustrates incidence angle characteristics in terms of transmittances and reflectances for p-polarized light in a fourth embodiment of the present invention.

FIG. 11 illustrates incidence angle characteristics in terms of transmittances and reflectances for s-polarized light in the fourth embodiment of the present invention.

FIG. 12 is an enlarged partial sectional view of the main portion of a polarization separation element of a fifth embodiment of the present invention.

FIG. 13 illustrates incidence angle characteristics in terms of transmittances and reflectances for p-polarized light in the fifth embodiment of the present invention.

FIG. 14 illustrates incidence angle characteristics in terms of transmittances and reflectances for s-polarized light in the fifth embodiment of the present invention.

FIG. 15 is a sectional view of the main portion of a polarization separation element of a sixth embodiment of the present invention.

FIG. 16 is an enlarged partial sectional view of the main portion of the polarization separation element of the sixth embodiment of the present invention.

FIG. 17 illustrates incidence angle characteristics in terms of transmittances and reflectances for p-polarized light in the sixth embodiment of the present invention.

FIG. 18 illustrates incidence angle characteristics in terms of transmittances and reflectances for s-polarized light in the sixth embodiment of the present invention.

FIG. 19 is a sectional view of the main portion of a polarization separation element of a seventh embodiment of the present invention.

FIG. 20 is a sectional view of the main portion of a polarization separation element of an eighth embodiment of the present invention.

FIG. 21 is a sectional view of an optical system in a ninth embodiment of the present invention.

FIG. 22 illustrates incidence angle characteristics in terms of transmittances and reflectances for p-polarized light in a related example.

FIG. 23 illustrates incidence angle characteristics in terms of transmittances and reflectances for s-polarized light in the related example.

### DESCRIPTION OF THE PREFERRED EMBODIMENTS

Hereunder, a description of the preferred embodiments of the present invention will be given.

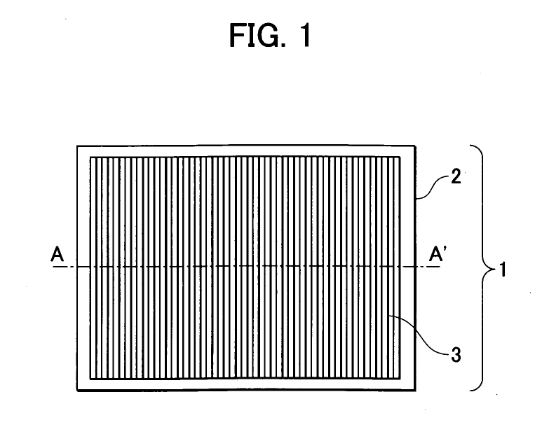

FIG. 1 is a front view of a polarization separation element of a first embodiment of the present invention. In FIG. 1, a polarization separation element 1 comprises a quartz substrate 2 and a diffraction grating 3 formed of aluminum (Al) and titanium nitride (TiN) and disposed on the quartz substrate 2.

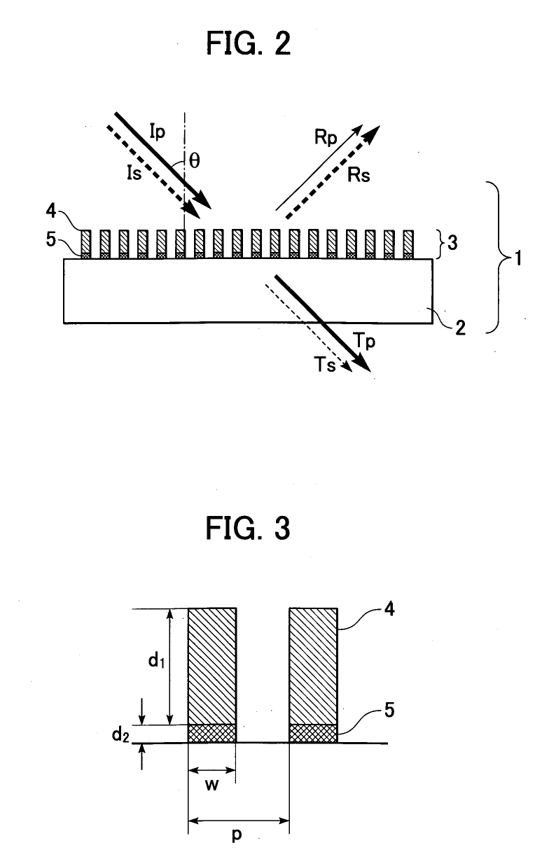

FIG. 2 is a schematic sectional view of the polarization separation element 1 of the first embodiment taken along line A-A′ in FIG. 1. An aluminum (Al) diffraction grating section 4 and a titanium nitride (TiN) diffraction grating section 5 are stacked upon each other on the quartz substrate 2.

FIG. 3 is an enlarged partial view of FIG. 2.

In the first embodiment, in order for the polarization separation element 1 to have high polarization separation capability in the entire visible range at an angle of incidence (θ) of 45 degrees, a grating period p is 77 nm (which is less than the wavelength of visible light), a grating width w is 37 nm, a thickness d₁ of the Al diffraction grating section 4 is 88 nm, and a thickness d₂ of the TiN diffraction grating section 5 is 8 nm.

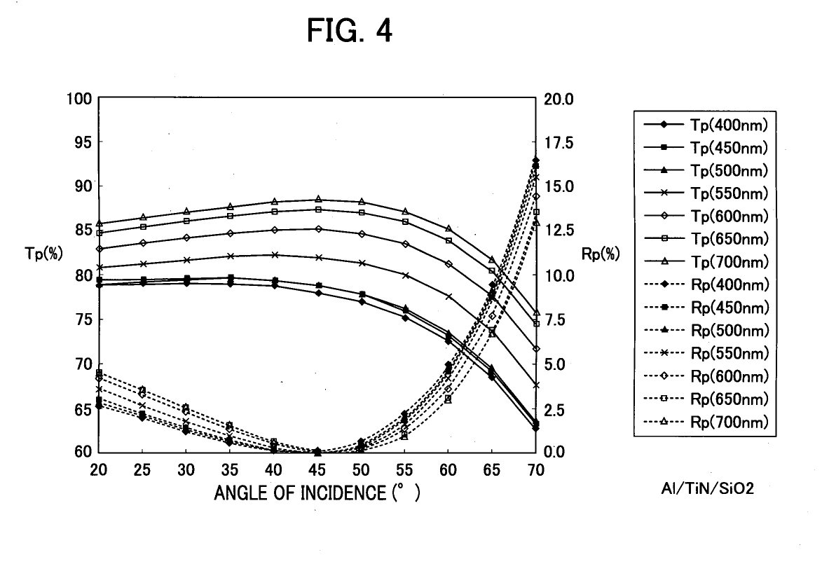

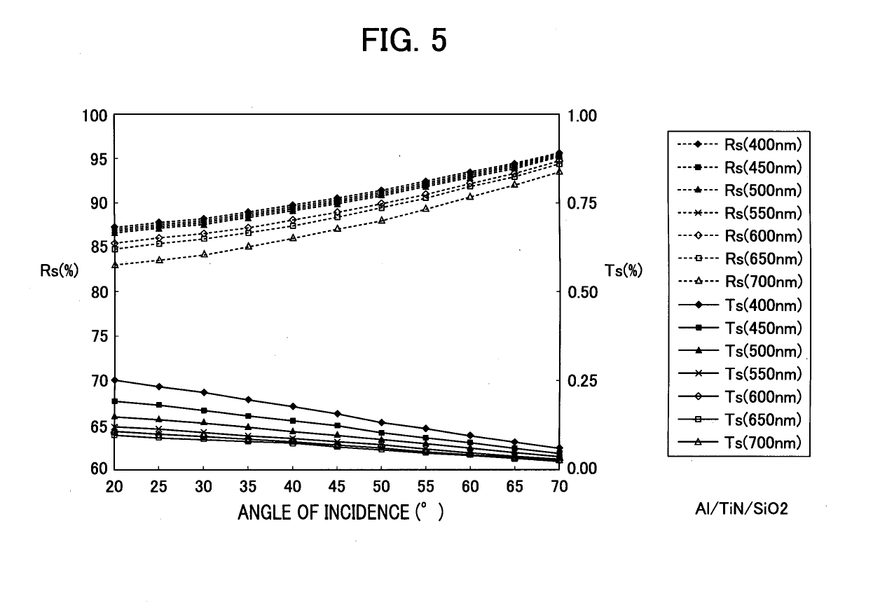

FIG. 4 illustrates incidence angle characteristics in terms of reflectances Rp and transmittances Tp when p-polarized light (direction of vibration of electrical field is perpendicular to a light-incident surface) having wavelengths in the visible range impinges upon the polarization separation element 1 of the first embodiment. FIG. 5 illustrates incidence angle characteristics in terms of reflectances Rs and transmittances Ts when s-polarized light (direction of vibration of electrical field is parallel to the light-incident surface) having wavelengths in the visible range impinges upon the polarization separation element 1 of the first embodiment. In FIGS. 4 and 5, Tp and Ts also represent transmittance curves for the p-polarized light and s-polarized light, respectively; and Rp and Rs denote reflectance curves for the p-polarized light and s-polarized light, respectively. In the other embodiments described later, the graphs are labeled in the same way.

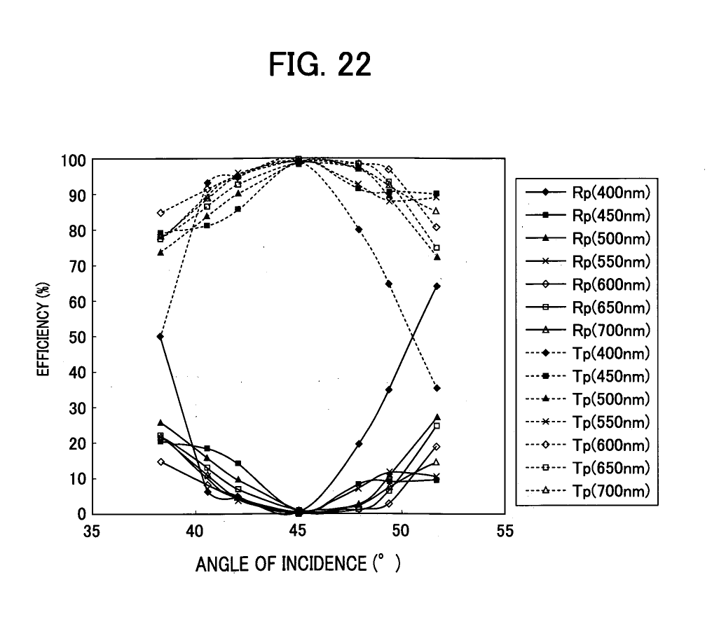

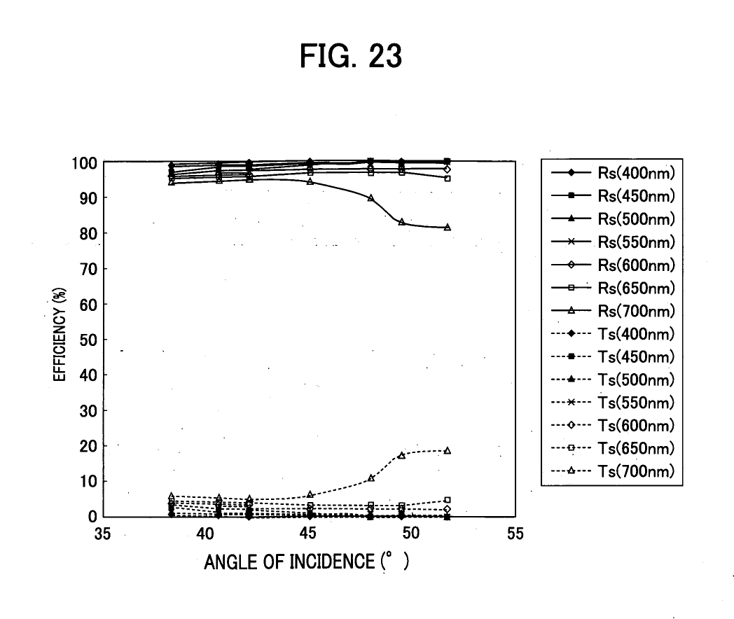

Compared to the related polarization separation element shown in FIG. 22, the polarization separation element 1 has poorer polarization separation capability at the design incidence angle of 45 degrees, but has a very small reduction in its polarization separation capability with changes in the angle of incidence.

The sum of the reflectance and the transmittance in the polarization separation element 1 of the first embodiment is not 100%. This is because the metallic diffraction grating absorbs a portion of the energy of the incident light. This energy is converted into Joule heat, so that, when the polarization separation element 1 is used in an optical system using a light source having high luminance, it becomes very hot.

However, in the first embodiment, the diffraction grating section 5 formed of TiN having a high melting point and having a small diffusion coefficient with respect to the quartz substrate 2 is disposed between the Al diffraction grating section 4 and the quartz substrate 2, so that the polarization separation element 1 has good incidence angle characteristics in the entire visible range, and is highly durable without any diffusion of the aluminum in the quartz substrate even at high temperatures.

A description of a second embodiment of the present invention will be given.

A polarization separation element of the second element has the same form as the polarization separation element of the first embodiment. The polarization separation element of the second embodiment comprises an aluminum (Al) diffraction grating 4, a quartz substrate 2, and a titanium (Ti) diffraction grating 5 disposed between the Al diffraction grating 4 and the quartz substrate 2. In order for the polarization separation element to have high polarization separation capability in the entire visible range at an angle of incidence (θ) of 45 degrees, a grating period p is 65 nm, a grating width w is 32 nm, a thickness d₁ of the Al diffraction grating 4 is 77 nm, and a thickness d₂ of the diffraction grating 5 is 12 nm.

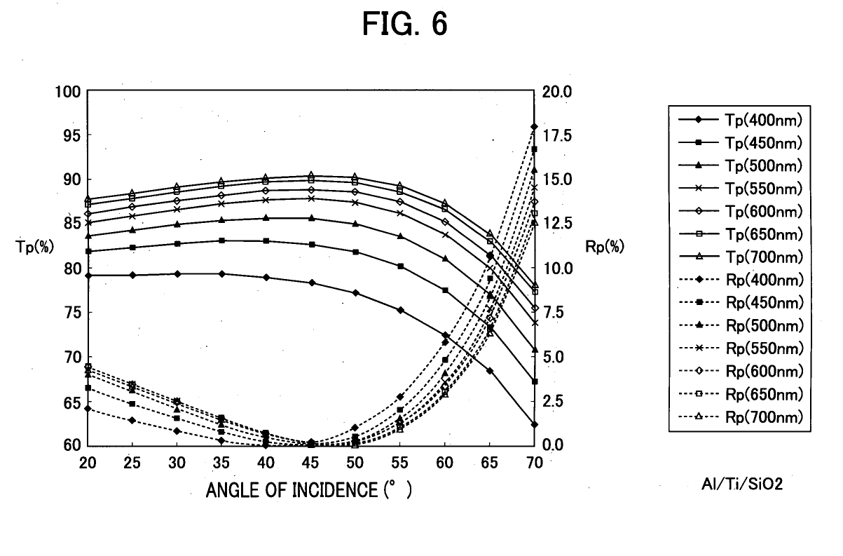

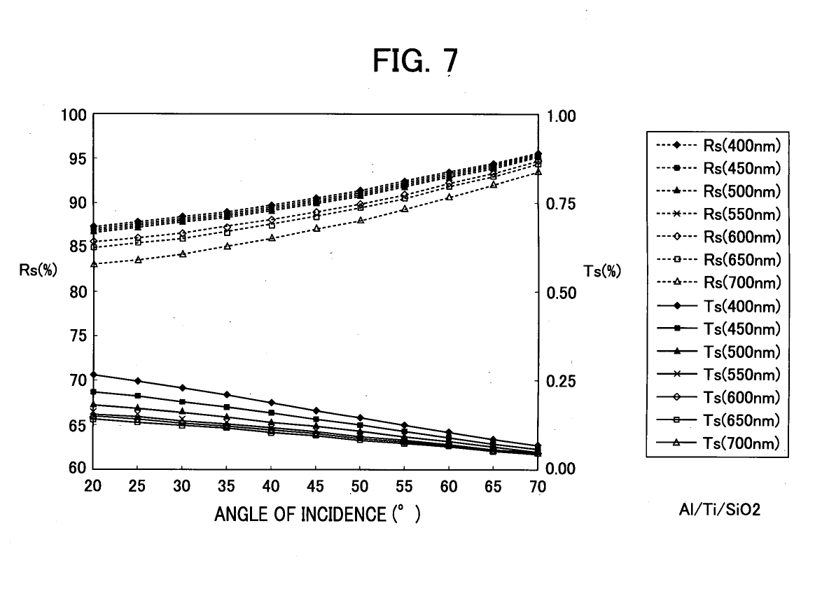

FIGS. 6 and 7 illustrate incidence angle characteristics in terms of transmittances and reflectances for p-polarized light and s-polarized light in the second embodiment of the present invention. FIGS. 6 and 7 both show that a reduction in the polarization separation capability of the polarization separation element of the second embodiment is small with changes in the angle of incidence.

Titanium has a melting point of 1666° C., which is at least 1000° C. higher than the melting point of aluminum, and has excellent adhesion with respect to quartz. In the second embodiment, the Ti diffraction grating 5 is disposed between the Al diffraction grating 4 and the quartz substrate 2, so that the polarization separation element is highly durable at high temperatures. When the diffraction gratings used in the second embodiment are produced by lithography, the diffraction gratings have excellent peeling resistance when a photoresist removal step is carried out during the production process, and production yield is increased.

Next, a third embodiment of the present invention will be described.

A polarization separation element of the third embodiment has the same form as the polarization separation elements of the first and second embodiments. The polarization separation element of the third embodiment comprises an aluminum (Al) diffraction grating 4, a quartz substrate 2, and a chromium (Cr) diffraction grating 5 disposed between the diffraction grating 4 and the quartz substrate 2. In order for the polarization separation element to have high polarization separation capability in the entire visible range with an angle of incidence (θ) of 45 degrees being a design incidence angle, a grating period p is 90 nm, a grating width w is 41 nm, a thickness d₁ of the Al diffraction grating 4 is 77 nm, and a thickness d₂ of the Cr diffraction grating 5 is 15 nm.

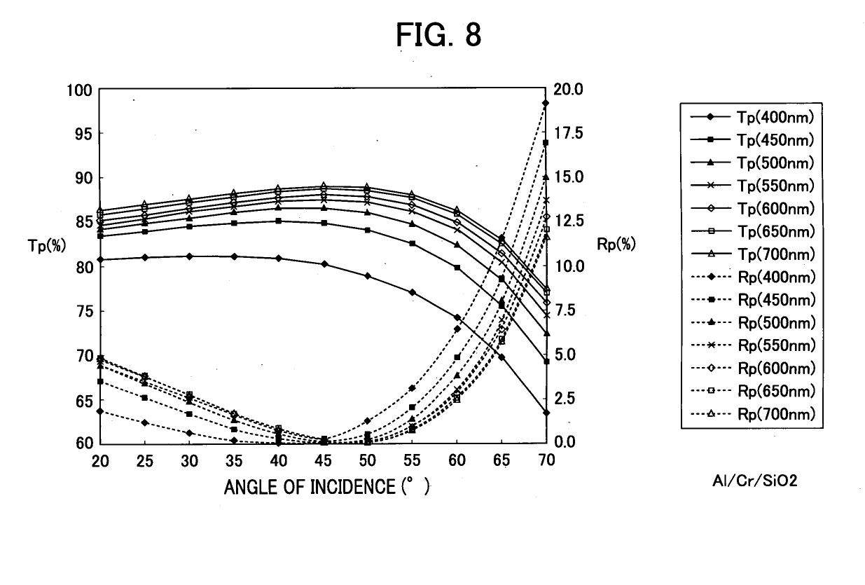

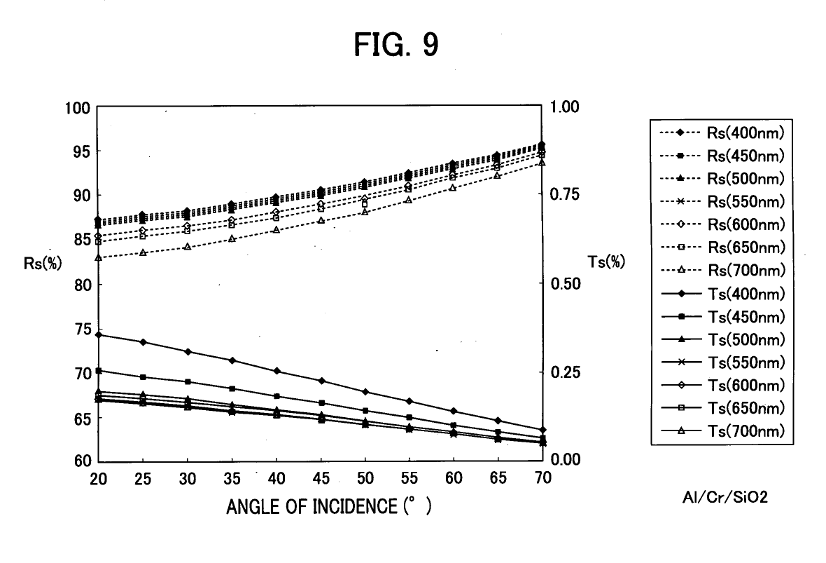

FIGS. 8 and 9 illustrate incidence angle characteristics in terms of transmittances and reflectances for p-polarized light and s-polarized light in the third embodiment of the present invention. FIGS. 8 and 9 both show that a reduction in the polarization separation capability of the polarization separation element of the third embodiment is small with changes in the angle of incidence.

Chromium has a melting point of 1857° C., which is much higher than the melting point of aluminum. In the third embodiment, the Cr diffraction grating 5 is disposed between the Al diffraction grating 4 and the quartz substrate 2, so that the polarization separation element is highly durable at high temperatures.

Next, a fourth embodiment of the present invention will be described.

A polarization separation element of the fourth embodiment has the same form as the polarization separation elements of the first to third embodiments. The polarization separation element of the fourth embodiment comprises an aluminum (Al) diffraction grating 4, a quartz substrate 2, and a silver (Ag) diffraction grating 5 disposed between the diffraction grating 4 and the quartz substrate 2. In order for the polarization separation element to have high polarization separation capability in a red light range (600 to 700 nm) with an angle of incidence (θ) of 45 degrees being a design incidence angle, a grating period p is 110 nm, a grating width w is 51 nm, a thickness d₁ of the Al diffraction grating 4 is 132 nm, and a thickness d₂ of the Ag diffraction grating 5 is 10 nm.

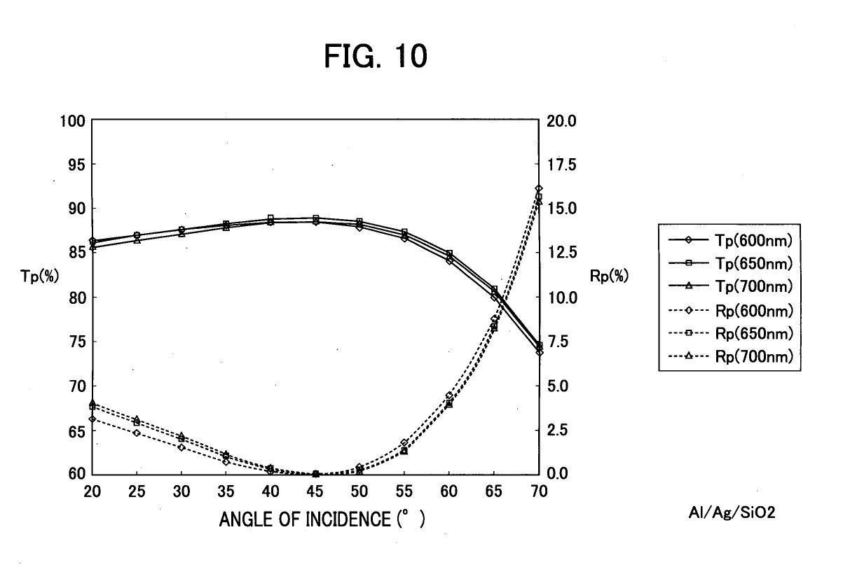

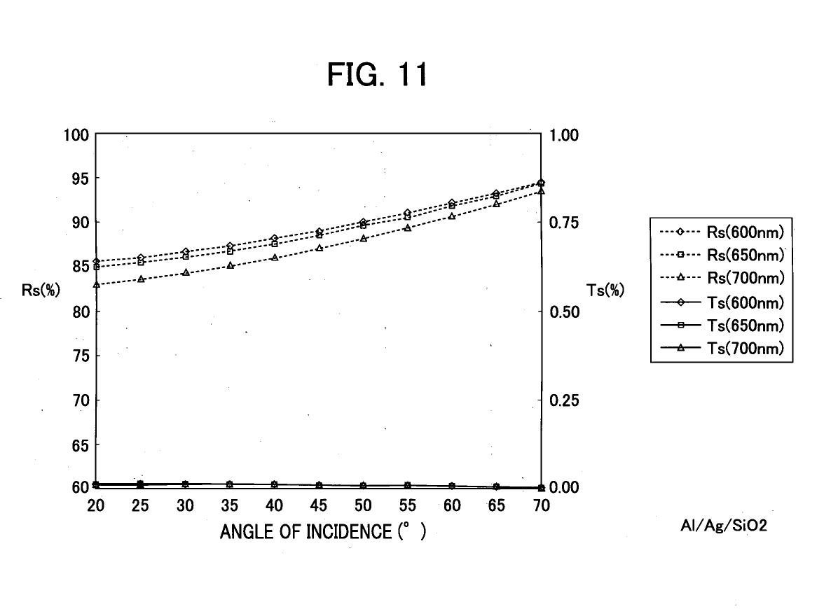

FIGS. 10 and 11 illustrate incidence angle characteristics in terms of transmittances and reflectances for p-polarized light and s-polarized light at wavelengths of 600 nm, 650 nm, and 700 nm in the fourth embodiment of the present invention. FIGS. 10 and 11 both show that a reduction in the polarization separation capability of the polarization separation element of the fourth embodiment is small with changes in the angle of incidence.

The melting point of silver is 962° C., which is higher than the melting point of aluminum. In the fourth embodiment, the Ag diffraction grating 5 is disposed between the Al diffraction grating 4 and the quartz substrate 2, so that the polarization separation element is highly durable at high temperatures.

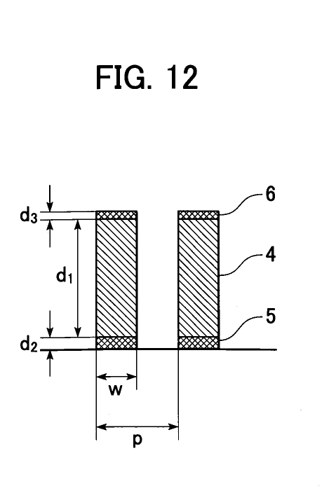

Next, a fifth embodiment of the present invention will be described. FIG. 12 is a sectional view of the main portion of a polarization separation element of the fifth embodiment of the present invention. In the fifth embodiment, an aluminum (Al) diffraction grating 4 and titanium (Ti) diffraction gratings 5 and 6 are disposed on a quartz substrate. The diffraction gratings 5 and 6 are also disposed on the bottom and top sides of the Al diffraction grating 4, respectively.

In the fifth embodiment, in order for the polarization separation element to have high polarization separation capability in the entire visible range at an angle of incidence (θ) of 45 degrees, a grating period p is 57 nm, a grating width w is 28.8 nm, a thickness d₁ of the Al diffraction grating 4 is 81 nm, a thickness d₂ of the Ti diffraction grating 5 is 8 nm, and a thickness d₃ of the diffraction grating 6 is 5 nm.

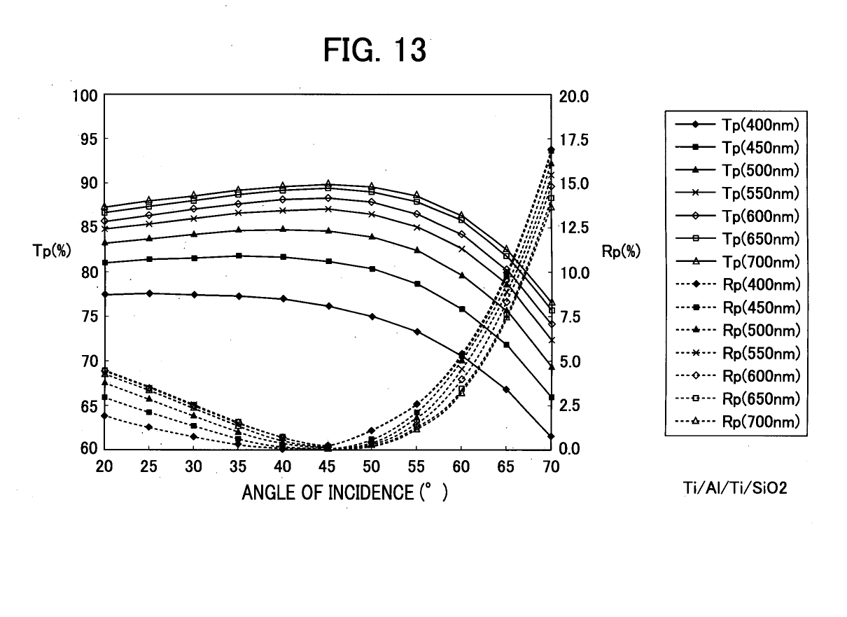

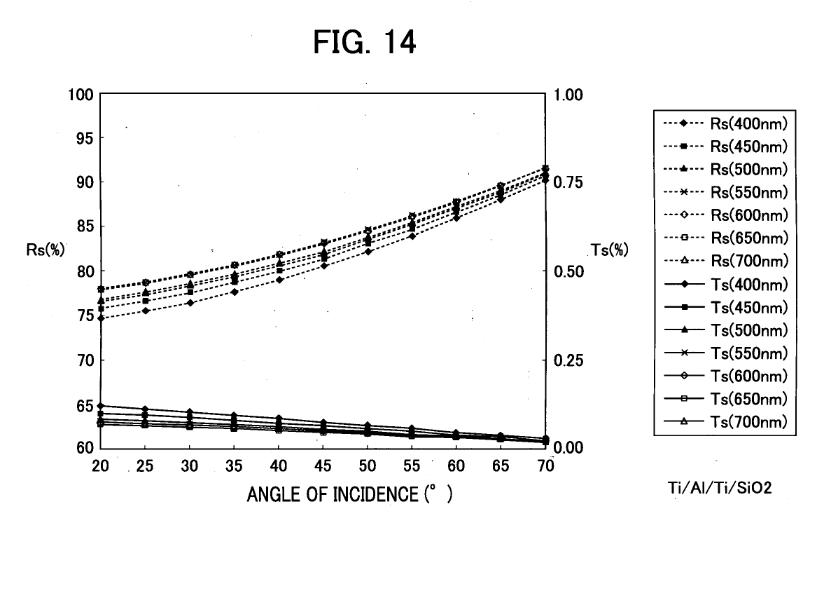

FIGS. 13 and 14 illustrate incidence angle characteristics in terms of polarization separation capability of the polarization separation element for p-polarized light and s-polarized light in the fifth embodiment of the present invention. FIGS. 13 and 14 both show that a reduction in the polarization separation capability of the polarization separation element of the fifth embodiment is small with changes in the angle of incidence.

The polarization separation element of the fifth embodiment comprises the Ti diffraction grating 6 (disposed on top of the diffraction grating 4) in addition to the Ti diffraction grating 5 disposed between the Al diffraction grating 4 and the quartz substrate. Therefore, in addition to the features of the second embodiment, the polarization separation element of the fifth embodiment provides the feature of allowing good controllability of a resist line width by restricting undesired reflection of light at an aluminum surface in a photolithography process, which is carried out when the polarization separation element is to be produced by lithography. Consequently, it is possible to produce polarization separation elements with high yield and having stabilized qualities.

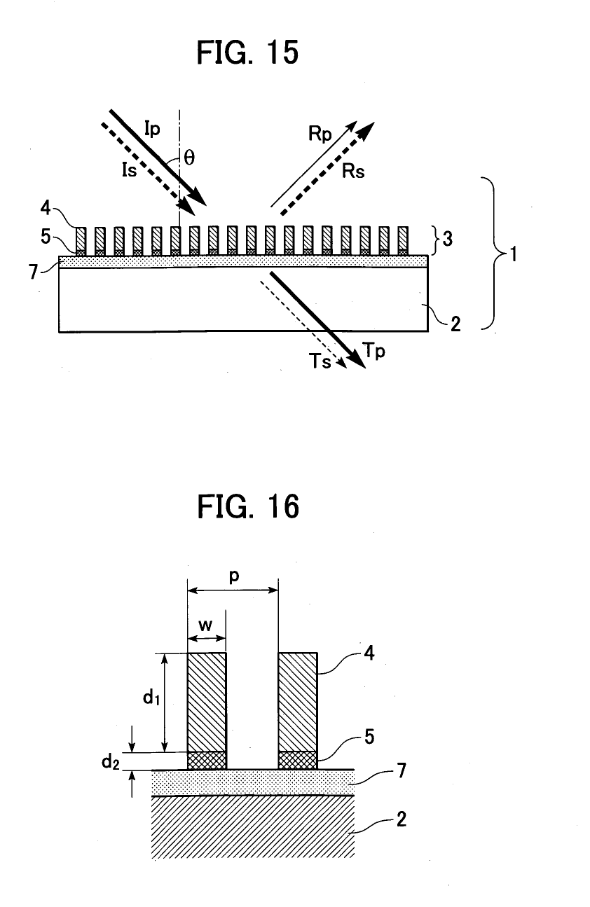

Next, a sixth embodiment of the present invention will be described. FIG. 15 is a sectional view of the main portion of a polarization separation element of the sixth embodiment. In the polarization separation element of the sixth embodiment, an MgF₂ film 7 is formed on a quartz substrate 2, and an aluminum (Al) diffraction grating 4 and a titanium (Ti) diffraction grating 5 are stacked upon each other on top of the MgF₂ film 7. FIG. 16 is an enlarged partial view of FIG. 15.

In the sixth embodiment, in order for the polarization separation element to have high polarization separation capability in the entire visible range at an angle of incidence (θ) of 45 degrees, at the MgF₂ film 7, a grating period p is 81 nm, a grating width w is 37.7 nm, a thickness d₁ of the Al diffraction grating 4 is 85 nm, and a thickness d₂ of the Ti diffraction grating 5 is 9 nm.

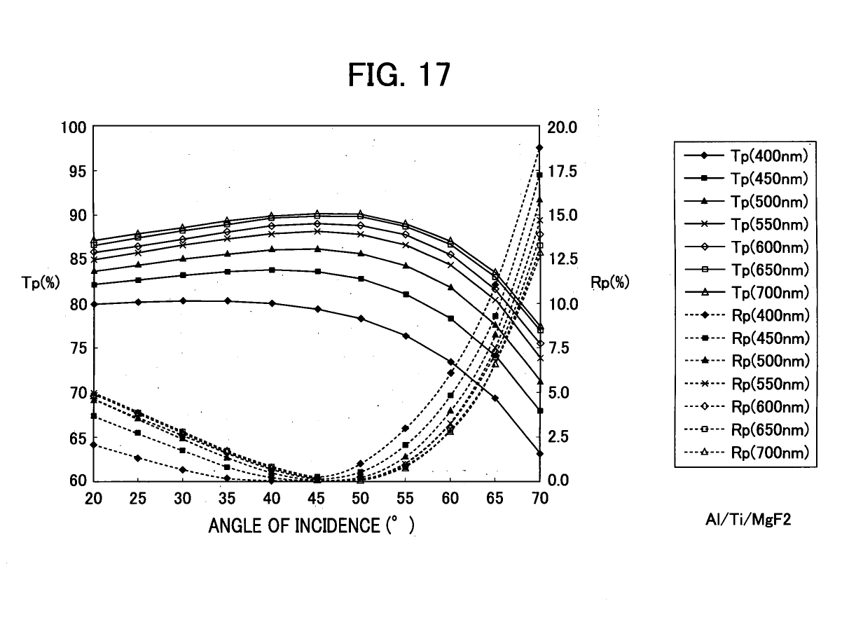

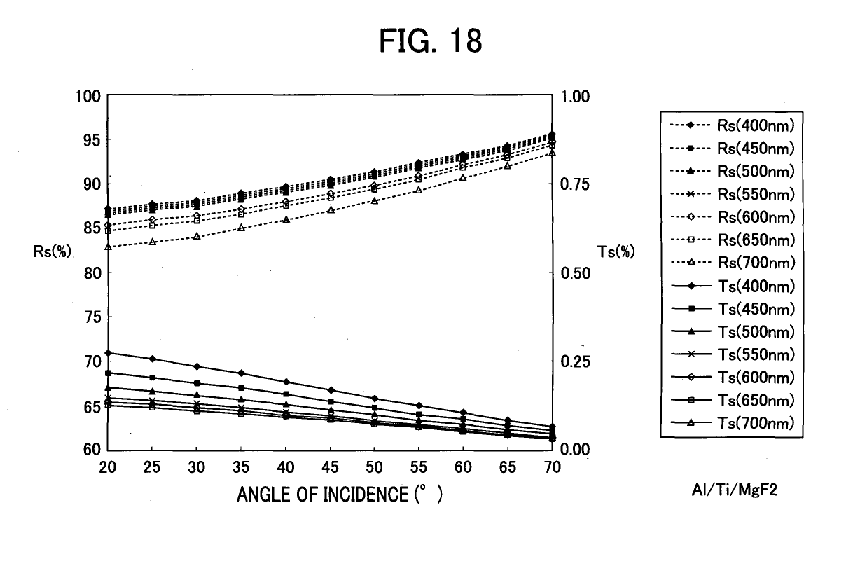

FIGS. 17 and 18 illustrate incidence angle characteristics in terms of transmittances and reflectances for p-polarized light and s-polarized light in the sixth embodiment of the present invention. FIGS. 17 and 18 both show that a reduction in the polarization separation capability of the polarization separation element of the sixth embodiment is small with changes in the angle of incidence.

Since the diffraction grating 5 formed of titanium having a high melting point is disposed between the Al diffraction grating 4 and the MgF₂ film 7, the polarization separation element of the sixth embodiment is highly durable at high temperatures. Since MgF₂ has a smaller refractive index than SiO₂ in the entire visible range, compared to the case where the diffraction grating 5 is formed directly formed on the quartz substrate, it is possible to provide a higher polarization separation capability.

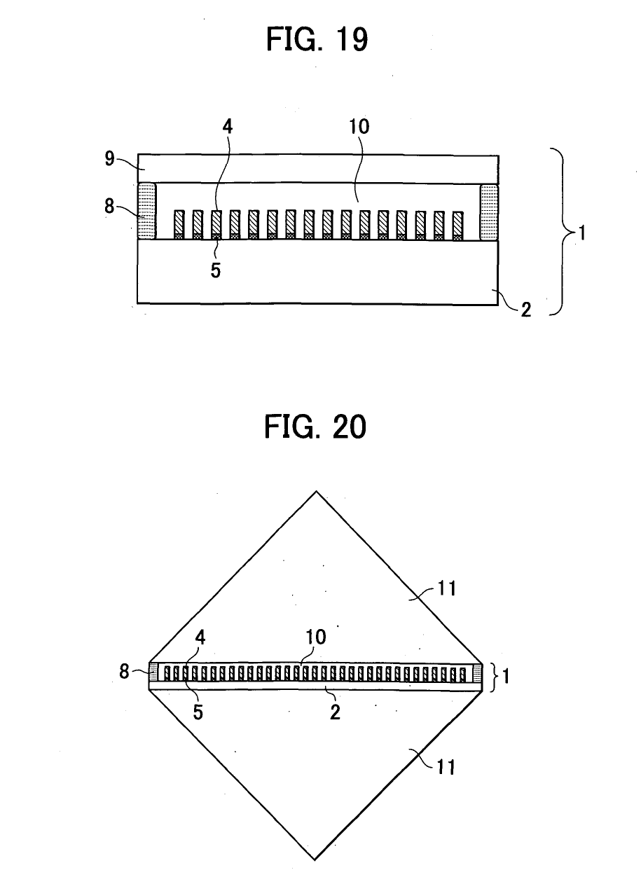

Next, a seventh embodiment of the present invention will be described. The seventh embodiment is an embodiment of a polarization separation element having a protective structure. FIG. 19 is a sectional view of the polarization separation element of the seventh embodiment. In FIG. 19, a spacer 8 and a transparent protective member 9 form the protective structure. Since an aluminum diffraction grating 4 and a diffraction grating 5, formed of a material having a higher melting point than aluminum, both of which have very fine structures are protected by the protective structure, the polarization separation element can be easily handled. Although a space 10 hermetically sealed by the spacer 8 and the transparent protective member 9 may be filled with air, it is desirable that the space 10 be filled with inert gas, such as helium, nitrogen, or argon.

By disposing the diffraction grating 5 between the Al diffraction grating 4 and a quartz substrate or an MgF₂ film, the polarization separation element is more durable at high temperatures. In addition, by disposing a structure for protecting the diffraction gratings 4 and 5 and filling a space formed by the protective structure with inert gas, it is possible to restrict corrosion of the diffraction gratings, caused by, for example, oxidation or moisture in the air, and breakage of the diffraction gratings due to handling of the polarization separation element. Therefore, the polarization separation element is highly durable and is easy to handle.

Next, a description of an eighth embodiment of the present invention will be given. The eighth embodiment is an embodiment in which a polarization separation element is installed at prism surfaces. Its structure is shown in FIG. 20. In FIG. 20, the polarization separation element is enlarged for illustration purposes. In the eighth embodiment, by adhering an aluminum (Al) diffraction grating 4 and a diffraction grating 5, formed of a material having a higher melting point than aluminum, to prisms 11 through a spacer 8, a polarization separation element 1 is disposed between two prisms. By virtue of such a structure, it is possible to protect the diffraction gratings 4 and 5 having very fine structures and to easily handle the polarization separation element 1. Although a space 10 hermetically sealed by the spacer 8 and the prisms 11 may be filled with air, it is desirable that the space 10 be filled with inert gas, such as helium, nitrogen, or argon.

By disposing the diffraction grating 5 between the Al diffraction grating 4 and a quartz substrate or an MgF₂ film, the polarization separation element is more durable at high temperatures. In addition, by adhering the diffraction gratings 4 and 5 to the prisms 11 through the spacer 8 so as to protect the diffraction gratings 4 and 5 and by filling the hermetically sealed space with an inert gas, it is possible to restrict corrosion of the diffraction gratings, caused by, for example, oxidation or moisture in the air, and breakage of the diffraction gratings 4 and 5 due to handling of the polarization separation element. Therefore, the prisms with the polarization separation element is highly durable and is easy to handle.

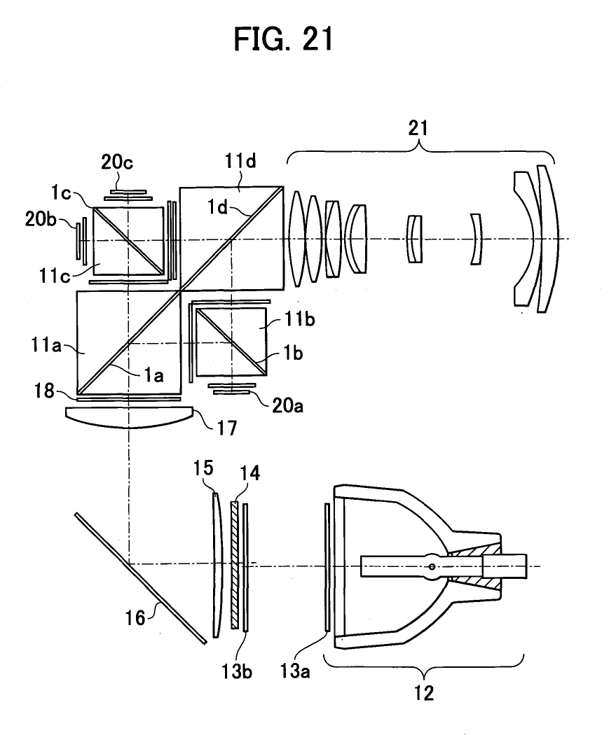

Next, a ninth embodiment of the present invention will be described. The ninth embodiment is an embodiment of an optical apparatus using polarization separation elements of the present invention. More specifically, it is an embodiment of a liquid crystal projector using polarization separation elements of the present invention in part of a projection optical system. FIG. 21 is a sectional view of an optical system in the ninth embodiment. In FIG. 21, reference numeral 12 denotes a light source, reference numerals 13a and 13b denote fly's eye integrators, reference numeral 14 denotes a polarization conversion element, reference numeral 15 denotes a condenser lens, reference numeral 16 denotes a total reflection mirror, reference numeral 17 denotes a field lens, reference numerals 20a, 20b, and 20c denote reflective liquid crystal panels, and reference numeral 21 denotes a projection lens. Reference numerals 11a to 11d denote prisms to which polarization separation elements 1a to 1d of the present invention are adhered.

In the polarization separation elements 1a, 1b, and 1c used here, by disposing diffraction gratings formed of metals and having periods that are shorter than wavelengths used, excellent polarization separation characteristics are provided for a wide angle of incidence. In addition, by disposing each diffraction grating 5, formed of a material having a higher melting point than aluminum, between its associated aluminum diffraction grating 4 and its associated quartz substrate or MgF₂ film, each polarization separation element is made more durable at high temperatures so that, even if a light source having very high luminance is used, the liquid crystal projector is highly durable.

The embodiments of the polarization separation elements and the embodiment of the optical apparatus using any of the polarization separation elements of the present invention are described. According to each of the embodiments, by disposing diffraction gratings formed of a plurality of metals or metallic compounds and having periods that are shorter than wavelengths used, good polarization separation characteristics are achieved in the entire wavelength region used and angle-of-view region used. In addition, by disposing between an aluminum diffraction grating and a substrate a metal or a metallic compound having a higher melting point than aluminum or having a small diffusion coefficient with respect to the substrate or having good adhesiveness with respect to the substrate, the polarization separation element is more durable at high temperatures. Therefore, in a liquid crystal projector or the like, it is possible to realize an optical system having high contrast and high luminance.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An optical element comprising:
a substrate;
a first diffraction grating disposed on the substrate and having a period that is shorter than a light wavelength used; and
a second diffraction grating disposed on the first diffraction grating and having a period that is shorter than the light wavelength used,
wherein the melting point of a material of the first diffraction grating is higher than the melting point of a material of the second diffraction grating.

2. An optical element according to claim 1, wherein the material of the first diffraction grating is at least one of a metal and a metallic compound, and wherein the material of the second diffraction grating is at least one of a metal and a metallic compound, and is different from the material of the first diffraction grating.

3. An optical element according to claim 1, wherein a diffusion coefficient of the material of the first diffraction grating is greater than a diffusion coefficient of the material of the second diffraction grating.

4. An optical element according to claim 1, wherein the materials of the first and second diffraction gratings are each any one of aluminum, gold, silver, chromium, zirconium, titanium, copper, tungsten, magnesium, tantalum, platinum, and a compound thereof.

5. An optical element according to claim 1, wherein a thin MgF₂ or Na₃AlF₆ film is disposed between the substrate and the first diffraction grating.

6. An optical element according to claim 1, wherein each grating period that is shorter than the light wavelength used falls in a range of from at least 30 nm to 200 nm at most.
